(19) United States
(12) Patent Application Publication
(10) Pub. No.: US 2019/0073929 A1
(43) Pub. Date: Mar. 7, 2019

(54) METHODS AND SYSTEMS FOR FORMING A TUBULAR STRUCTURE HAVING INDICIA ON AN INTERIOR SURFACE

(71) Applicant: Bull Moose Tube Company, Chesterfield, MO (US)

(72) Inventors: Marlon Edwin Robinson, Lake Saint Louis, MO (US); Mark Scott Abernathy, Ballwin, MO (US)

(21) Appl. No.: 15/695,459

(22) Filed: Sep. 5, 2017

(51) Int. Cl. G09F 3/00

(52) U.S. Cl. CPC G09F 3/0295; B44B 5/0095

(57) ABSTRACT

A method of forming a tubular structure includes mechanically pickling a metal strip. The metal strip includes opposing first and second surfaces. The method also includes stippling indicia onto the first surface of the metal strip. The indicia includes an informational pattern. The method further includes forming the metal strip into a tubular structure such that the first surface forms an interior surface of the tubular structure.

### BACKGROUND

The field of the disclosure relates generally to tubular structures and, more particularly, to methods and systems for use in providing tubular structures with informational indicia on their interior surface.

At least some known tubular structures include indicia printed on their interior surfaces, for example to convey manufacturing origin data, system data, and/or other information. However, at least some known methods for printing such indicia are not conducive to use on tubular structures having a relatively small diameter, such as but not limited to pipes used in fire suppression sprinkler systems. In addition, at least some known tubular structures must be subjected to suitable processes, such as pickling, to remove any scale, rust, or corrosion from the surface of the tubular structure, for example to avoid contamination of a material to be conveyed through the tubular structure and/or to facilitate stability of paint or other coatings applied to the interior or exterior surface of the tubular structure. However, such processes tend to obscure or interfere with printed indicia on the interior of the tubular structure. Moreover, at least some known pickling process are acid-based, which can be time consuming and requires additional manufacturing processes to clean the tubular structure and remove traces of the acid used in the pickling process.

### BRIEF DESCRIPTION

In one aspect, a method of forming a tubular structure is provided. The method includes mechanically pickling a metal strip. The metal strip includes opposing first and second surfaces. The method also includes stippling indicia onto the first surface of the metal strip. The indicia includes an informational pattern. The method further includes forming the metal strip into a tubular structure such that the first surface forms an interior surface of the tubular structure.

In another aspect, a system for forming a tubular structure is provided. The system includes a pickling chamber configured to mechanically pickle a metal strip. The metal strip includes opposing first and second surfaces. The system also includes a stippling device configured to receive the metal strip from the pickling chamber and to stipple indicia onto the first surface of the metal strip. The indicia includes an informational pattern. The system further includes a forming device configured to receive the metal strip from the stippling device and to form the metal strip into a tubular structure, such that the first surface forms an interior surface of the tubular structure.

### BRIEF DESCRIPTION OF THE DRAWINGS

FIG. 1 is a schematic exploded illustration of an exemplary fire suppression sprinkler system;

FIG. 2 is a schematic view of an exemplary tubular structure that may be used with the fire suppression sprinkler system shown in FIG. 1;

FIG. 3 is a flow diagram of an exemplary system for forming the tubular structure shown in FIG. 2;

FIG. 4 is a plan view of a metal strip used to form the tubular structure at location 4 designated in FIG. 3; and

FIG. 5 is a detail of region 5 designated in FIG. 4.

### DETAILED DESCRIPTION

The following detailed description illustrates tubular structures with indicia on their inner surface and methods and systems for forming the same by way of example and not by way of limitation. The description enables one of ordinary skill in the art to make and use the tubular structures, and the description describes several embodiments of the tubular structures, including what is presently believed to be the best modes of making and using the tubular structures. Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

Exemplary tubular structures having indicia are described herein as having indicia created on an interior surface utilizing a stippling process, and as having undergone a mechanical pickling process that does not employ an acid-based solution. However, it is contemplated that tubular structures with indicia on their inner surface that undergo a mechanical pickling process have various embodiments, including, but not limited to having indicia on other surfaces.

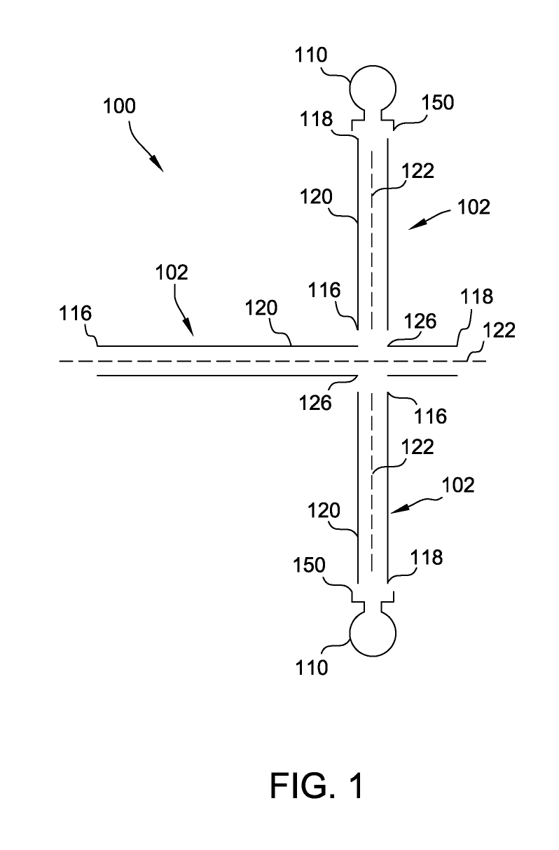

FIG. 1 is a schematic exploded illustration of an exemplary fire suppression sprinkler system 100. In the exemplary embodiment, fire suppression sprinkler system 100 includes a plurality of elongated tubular structures 102, such as pipes. Sprinkler system 100 also includes a plurality of sprinkler heads 110 coupled in flow communication with tubular structures 102. For example, a first tubular structure 102 functions as a main (or feed) line of sprinkler system 100, while other tubular structures 102 function as branch lines of sprinkler system 100. In other embodiments, each tubular structure 102 may function as any suitable type of line in sprinkler system 100. Although sprinkler system 100 has three tubular structures 102 in the exemplary embodiment, sprinkler system 100 may have any suitable number of tubular structures 102 in other embodiments.

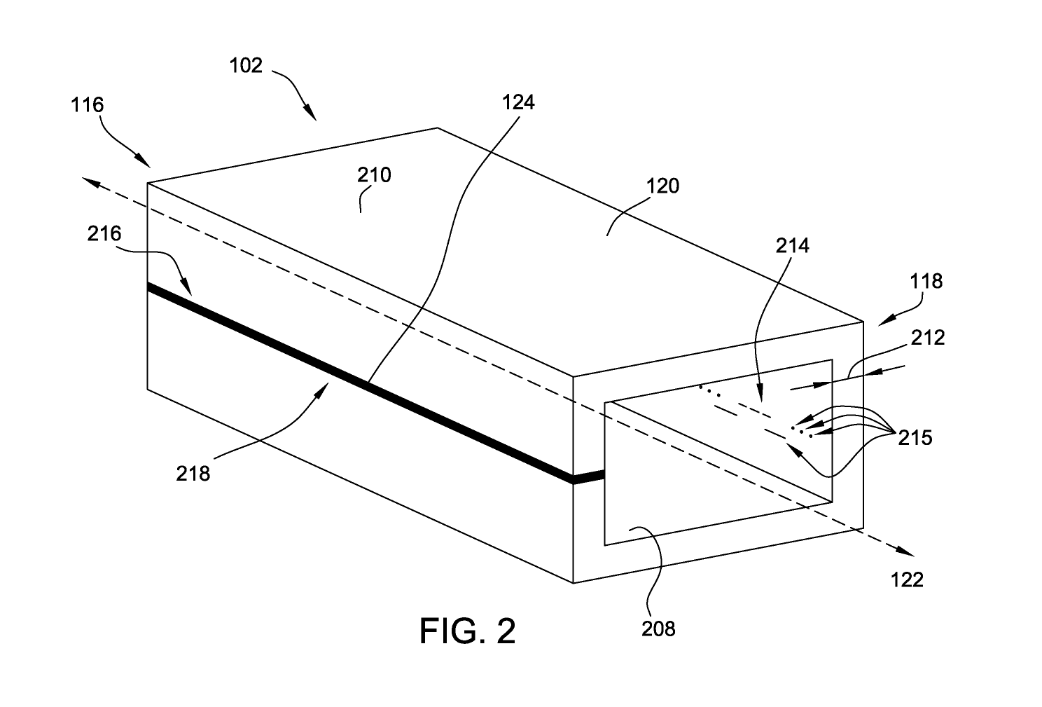

In the exemplary embodiment, each tubular structure 102 has a first end 116, a second end 118, and an elongated hollow body 120 extending from first end 116 to second end 118 along a longitudinal axis 122, such that first end 116 and second end 118 are open ends. Each body 120 has a single seam 124 (shown in FIG. 2), such as, for example, a welded seam, that extends longitudinally from first end 116 to second end 118. Body 120 of main tubular structure 102 includes apertures 126 defined therethrough between first end 116 and second end 118 to facilitate coupling main tubular structure 102 in flow communication to open first ends 116 of respective branch tubular structures 102. Alternatively, each tubular structure 102 includes any suitable number of seams and/or apertures, including zero, oriented in any suitable manner. For example, at least one tubular structure 102 may be seamless in other embodiments. Additionally, although first end 116 and second end 118 of each tubular structure 120 are open ends in the exemplary embodiment, at least one of first end 116 and second end 118 of at least one tubular structure 102 is a closed end in other embodiments.

In the exemplary embodiment, branch tubular structures 102 are mechanically coupled to main tubular structure 102 at respective apertures 126 via a suitable hollow component fitting (not shown), or alternatively bonded (e.g., welded) directly to body 120 at respective apertures 126. In other embodiments, branch tubular structures 102 are coupled to main tubular structure 102 in any suitable fashion.

In the exemplary embodiment, a first of sprinkler heads 110 is coupled to second end 118 of one of branch tubular structures 102 via a first fitting 150, and a second of sprinkler heads 110 is coupled to second end 118 of another of branch tubular structures 102 via a second fitting 150. In other embodiments, each sprinkler head 110 may be coupled to tubular structures 102 at any suitable location along body 120, such as at another aperture defined through body 120. Moreover, although tubular structures 102 are illustrated as directly coupled to at most only one sprinkler head 110 in the exemplary embodiment, any suitable number of sprinkler heads 110 may be coupled to each tubular structure 102 in other embodiments.

During operation of fire suppression sprinkler system 100, a liquid (not shown) such as water, for example, flows to sprinkler heads 110 via tubular structures 102. In some embodiments, tubular structures 102 may be substantially filled with the liquid until sprinkler system 100 is tested or otherwise used to suppress a fire (i.e., the liquid may sit stagnant in tubular structures 102, flowing therethrough only periodically during a testing event or when used to suppress a fire). In other embodiments, tubular structures 102 may be substantially empty (i.e., substantially not filled with liquid) until sprinkler system 100 is tested or otherwise used to suppress a fire (i.e., the liquid may not be supplied to tubular structures 102 until a testing event or fire-suppression event occurs).

FIG. 2 is a perspective view of an exemplary embodiment of tubular structure 102 that may be used with fire suppression sprinkler system 100. Alternatively, tubular structure 102 is any suitable tubular structure for use in any suitable application. Body 120 has a first, interior surface 208 and an opposite second, exterior surface 210 positioned radially outward from first surface 208. First and second surfaces 208 and 210 define a thickness 212 therebetween. In the exemplary embodiment, tubular structure 102 includes a longitudinally extending first edge 216 coupled to a corresponding longitudinally extending second edge 218 along a longitudinally extending seam 124. For example, seam 124 is a weld between edges 216 and 218. Alternatively, edges 216 and 218 are joined along seam 124 in any suitable fashion. In the exemplary embodiment, a cross-section of body 120 is round. In alternative embodiments, the cross-section of body 120 is square, rectangular, triangular, ovoid, elliptical, or any other suitable shape.

In the exemplary embodiment, body 120 is formed from a metallic material. For example, body 120 is formed from a steel alloy. Alternatively, body 120 is formed from any suitable material that enables tubular structure 102 to function as described herein. In some embodiments, thickness 212 is within a range from about 0.025 inches to about 0.500 inches. Alternatively, thickness 212 is any suitable thickness that enables tubular structure 102 to function as described herein.

In the exemplary embodiment, first surface 208 includes indicia 214 defined thereon. Indicia 214 is an informational pattern visible on first surface 208. For example, indicia 214 encodes manufacturing and/or origin data associated with tubular structure 102, such as manufacturer name and location, date of manufacture, and lot and/or batch numbers associated with tubular structure 102. Additionally or alternatively, indicia 214 encodes any other suitable information associated with tubular structure 102. Indicia 214 includes at least one element 215. For example, each element 215 is at least a portion of a symbolic or coded marking, such as a line, dash, or dot. In some embodiments, the at least one element 215 includes alphanumeric characters (not shown).

In some embodiments, first, interior surface 208 of tubular structure 102 is chemically and/or mechanically treated during manufacture of tubular structure 102, such as, but not by way of limitation, to reduce surface roughness and/or corrosion of interior surface 208, and/or to reduce microbial growth inside tubular structure 102. For example, tubular structure 102 is part of fire suppression sprinkler system 100 (shown in FIG. 1), and first surface 208 is treated to reduce the surface roughness to facilitate increasing a rate that liquid flows through tubular structure 102, reducing a pressure loss of flow within tubular structure 102, and/or reducing an amount of corrosion and/or microbiological growth that occurs within tubular structure 102. Additionally or alternatively, second surface 210 of tubular structures 102 is painted to more inexpensively reduce corrosion and/or improve an exterior aesthetic appearance of tubular structure 102, such that outer surface 210 is a less viable option for indicia 214.

Some such treatments and/or coatings are not fully compatible with at least some known methods of defining indicia 214 on first surface 208, such as printing indicia 214 on first surface 208 with ink, paint, or the like. For example, at least some such treatments and/or coatings performed prior to printing indicia 214 on first surface 208 interfere with initial adhesion of indicia 214 to first surface 208, and/or tend to corrupt or fade printed indicia 214 on first surface 208 over time. For another example, at least some such treatments and/or coatings performed after printing indicia 214 on first surface 208 tend to obscure indicia 214 and/or tend to corrupt or fade printed indicia 214 on first surface 208 over time. In addition, in at least some cases, indicia 214 on first surface 208 may be particularly useful after tubular structure 102 is subjected to an extreme environment that tends to further corrupt or fade printed indicia 214. For example, tubular structure 102 is part of fire suppression sprinkler system 100 (shown in FIG. 1), and manufacturing origin data evidenced by indicia 214 aids an investigation of the performance of fire suppression sprinkler system 100 in response to a fire suppression event. Such events may also tend to damage second, outer surface 210 to a greater extent than first surface 208, further reducing a viability of outer surface 210 for indicia 214. On the other hand, at least some non-printing methods of defining indicia 214 on first surface 208, such as stamping elements 215 into first surface 208, locally reduce thickness 212 over a sufficiently large area to alter a structural strength of body 120, in particular for thickness 212 of about 0.500 inches or less as discussed above, although greater thicknesses may also be affected. Thus, in some embodiments, stamping indicia 214 into body 120 may require an increased initial material thickness 212 and, hence, an increased cost of body 120, in order to meet safety margins.

In the exemplary embodiment, indicia 214 is defined on first surface 208 via stippling of first surface 208. The term “stippling” refers to each element 215 of indicia 214 being defined by a plurality of separate points 217 (shown in FIG. 5) indented into first surface 208, rather than by a continuous indentation as would be formed by stamping each element 215 into first surface 208. Stippled points 217 of elements 215 define relatively small, discontinuous local decreases in thickness 212 that alter a structural strength of body 120 to a lesser extent, as compared to each element 215 being formed by a respective continuous stamp into first surface 208 to produce a like visibility of elements 215. Moreover, in some embodiments, indicia 214 defined on first surface 208 via stippling improves a compatibility of indicia 214 with various pre- and post-stippling processes that may be performed on first surface 208, and/or improves a persistence of indicia 214 on first surface 208 after exposure to extreme environments.

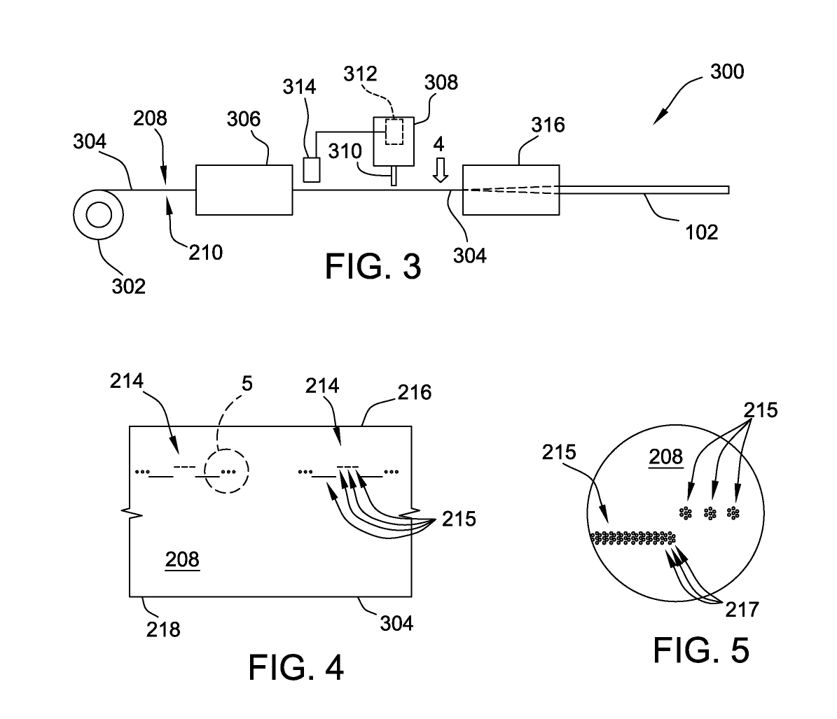

FIG. 3 is a schematic view of an exemplary system 300 for forming tubular structure 102. In the exemplary embodiment, a strip 304 of material is uncoiled from a coil 302. For example, coil 302 is a coil of stainless steel formed in a suitable cold rolled process. For another example, coil 302 is a coil of stainless steel formed in a suitable hot rolled process. Alternatively, strip 304 is initially provided as a flat plate of stainless steel, rather than uncoiled from coil 302. Alternatively, strip 304 is any suitable material provided in any suitable fashion that enables tubular structure 102 to be formed as described herein.

FIG. 4 is a plan view of strip 304 at location 4 designated in FIG. 3. FIG. 5 is a detail view of region 5 designated in FIG. 4. With reference to FIGS. 3-5, strip 304 includes first surface 208 and opposite second surface 210, configured to become the interior and exterior surfaces, respectively, of tubular structure 102, as described above. Each of first surface 208 and second surface 210 of strip 304 initially extends in substantially planar fashion from first edge 216 to second edge 218. As described above, edges 216 and 218 are configured to couple together along seam 124 (shown in FIG. 2) to form tubular structure 102 from strip 304.

In the exemplary embodiment, strip 304 is mechanically pickled. As used herein, the term “mechanically pickled” indicates that the pickling process does not involve the use of acid. In the exemplary embodiment, strip 304 is pickled in a chamber 306. For example, chamber 306 is a wet abrasion chamber, in which a slurry of fine metallic particles in a carrier liquid, such as water, is blasted against first surface 208 and second surface 210, such that oxides and other surface impurities and/or foreign matter are substantially removed from first surface 208 and second surface 210. In some such embodiments, the carrier liquid further includes a suitable cleaning or conditioning agent that, for example, inhibits subsequent oxide formation on first surface 208 and second surface 210. For another example, chamber 306 is a dry abrasion chamber, in which abrasive particles are dry blasted or peened against first surface 208 and second surface 210, such that metal oxides and other surface impurities and/or foreign matter are substantially removed from first surface 208 and second surface 210. In some such embodiments, strip 304 is subsequently washed with water and/or a suitable cleaning or conditioning agent to further remove the detritus of dry blasting and/or inhibit subsequent oxide formation on first surface 208 and second surface 210. Alternatively, strip 304 is pickled in any suitable fashion that enables tubular structure 102 to function as described herein.

In the exemplary embodiment, indicia 214 is stippled onto first surface 208 of strip 304 using a suitable stippling device 308. For example, stippling device 308 includes at least one computer numerically controlled (CNC) punch tool 310 and a programmable controller 312 that is operable to automatically move the at least one punch tool 310 to form each stippled point 217 of indicia 214 at preselected locations on first surface 208. For example, programmable controller 312 is operable to receive input data specifying the contents of indicia 214 (e.g., manufacturing plant location, material batch number associated with strip 304, manufacturing line identification associated with forming device 316 described below, and the like) and/or instructions to generate at least one dynamic portion of indicia 214 (e.g., date and time of day), instructions specifying the preselected locations on strip 304 at which to add indicia 214, and instructions regarding a preselected depth at which to indent stippled points 217 into first surface 208. Programmable controller 312 is operable to automatically convert the provided and/or generated indicia information into movements of the at least one punch tool 310 that create the stippled points 217 corresponding to elements 215 (e.g., alphanumeric characters or codes) of indicia 214 on first surface 208 at the preselected locations. Alternatively, stippling device 308 is configured to receive information specifying the contents and preselected locations of indicia 214, and to convert the information into stippled points 217, in any suitable fashion.

In some embodiments, as strip 304 is conveyed past stippling device 308, programmable controller 312 is operable to move the at least one punch tool 310 back and forth between edges 216 and 218 of strip 304, transversely to the direction of travel of strip 304, to add indicia 214 at the preselected locations. Additionally or alternatively, a position of strip 304 relative to stippling device 308 is held constant during at least a portion of the stippling operation. Moreover, in some embodiments, programmable controller 312 is operable to move the at least one punch tool 310 longitudinally with respect to strip 304 to further facilitate adding indicia 214 at the preselected locations. As the at least one punch tool 310 reaches each preselected location, programmable controller 312 is operable to automatically extend the at least one punch tool 310 into depressive contact with first surface 208 to the preselected depth to form stippled points 217.

In certain embodiments, a transverse component of the preselected locations is provided to programmable controller 312 in coordinates relative to one of edges 216 and 218, and a longitudinal component of the preselected locations is provided in coordinates of relative spacing along strip 304, such that indicia 214 are repeated along first surface 208 at preselected distance intervals. In alternative embodiments, the preselected locations for indicia 214 are provided to programmable controller 312 in any suitable fashion. In some embodiments, programmable controller 312 is operable to receive feedback from suitable sensors 314 that provide information regarding a position of edges 216 and 218 and a speed of travel of strip 304 relative to stippling device 308, and to identify the preselected locations on strip 304 based on the sensor feedback. In alternative embodiments, stippling device 308 is configured to identify the preselected locations on strip 304 in any suitable fashion.

In the exemplary embodiment, controller 312 is implemented using one or more electronic computing devices. Such devices typically include at least one processing device (not shown) such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein, including steps that controller 312 is configured to perform, may be encoded as executable instructions embodied in a computer readable medium, including, without limitation, a non-transitory storage device and/or a memory device coupled to the at least one processor. Such instructions, when executed by the controller or processing device, cause the controller or processing device to perform at least some of the method steps described herein. Although controller 312 is illustrated as a discrete system, controller 312 may be implemented at least partially by at least one processor embedded within any component of system 300. The above examples are exemplary only, and thus are not intended to limit in any way the definition and/or meaning of the terms controller and processing device.

In the exemplary embodiment, indicia 214 is stippled onto first surface 208 after strip 304 is mechanically pickled. In some embodiments, adding indicia 214 to first surface 208 after mechanical pickling improves an accuracy and consistency of a depth of depression of stippled points 217 into first surface 208, and/or reduces unintended impressing of oxides and other surface impurities and/or foreign matter into first surface 208 during stippling. Although FIG. 3 illustrates stippling device 308 as configured to receive metal strip 304 from pickling device 306, such that the stippling operation occurs on the same manufacturing line as the mechanical pickling operation, in alternative embodiments the stippling operation may be performed at a later time and/or location. In other alternative embodiments, indicia 214 is stippled onto first surface 208 before strip 304 is mechanically pickled.

In the exemplary embodiment, after indicia 214 is added to first surface 208 of strip 304, strip 304 is formed into tubular structure 102 by a forming device 316. For example, but not by way of limitation, forming device 316 feeds strip 304 through an array of rollers to form an open-seam tubular structure having edges 216 and 218 positioned adjacent to each other, and through a welding process that fuses edges 216 and 218 together along seam 124 to form tubular structure 102. First surface 208 having indicia 214 impressed therein becomes the interior surface of tubular structure 102, as described above. The details of many such suitable tube-forming processes are well known in the art, and need not be repeated here. Although FIG. 3 illustrates forming device 316 as configured to receive metal strip 304 from stippling device 308, such that the forming operation occurs on the same manufacturing line as the stippling operation, in alternative embodiments the forming operation may be performed at a later time and/or location.

In some embodiments, tubular structure 102 is subjected to any of a number of post-manufacturing processes, and indicia 214 positioned on first, interior surface 208 are advantageously unobscured and uncorrupted by, and do not substantially interfere with, such processes. For example, but not by way of limitation, a coating (not shown) is applied to first, interior surface 208, such as a coating configured to reduce an amount of corrosion and/or microbiological growth that occurs within tubular structure 102, as discussed above. For another example, but not by way of limitation, tubular structure 102 may be air-or-water cooled, heat treated, straightened, ultrasonically inspected, and/or hydrostatically tested. Moreover, second, outer surface 210 may be painted or otherwise coated.

Although the exemplary embodiment includes tubular structures 102 in the form of pipes for use in fire suppression sprinkler system 100, it is also contemplated that tubular structures 102 may be fabricated in a similar manner for use in other structures or systems, such as but not limited to: (1) a hollow structural section (HSS) for a building exterior, an oil platform, a trailer body, construction/agricultural equipment, roadway equipment (e.g., roadway signs, guardrails, etc.); (2) at least one component of a healthcare-related device (e.g., a hospital bed, a wheelchair, etc.); (3) at least one component of a piece of equipment for use outdoors (e.g., the handle(s) thereof); (4) at least one component of a piece of outdoor furniture; and (5) at least one component of sporting and/or fitness goods/equipment. Thus, although tubular structure 102 is described above with respect to fire suppression sprinkler system 100, other suitable uses for the systems and methods described herein are also contemplated without departing from the scope of this disclosure.

The methods and systems described herein facilitate forming tubular structures with indicia stippled on an interior surface such that a structural strength of the tubular structure is substantially maintained, even for tubular structures having wall thicknesses of about 0.5 inches or less. In at least some embodiments, the indicia are compatible with pre- and post-processing of the tubular structure such as, for example, mechanical pickling and/or the application of coatings to inhibit corrosion and/or microbiological growth within the tubular structure. Additionally or alternatively, in at least some embodiments, the indicia are sufficiently durable to enable reading of the indicia even after the tubular structure is subjected to an extreme environment, such as but not limited to an environment associated with a fire suppression event.

Exemplary embodiments of tubular structures with indicia on their inner surface that have undergone a mechanical pickling process and methods of assembling the same are described above in detail. The methods and systems described herein are not limited to the specific embodiments described herein, but rather, components of the methods and systems may be utilized independently and separately from other components described herein. For example, the methods and systems described herein may have other applications not limited to practice with tubular structures, as described herein. Rather, the methods and systems described herein can be implemented and utilized in connection with various other industries.

While the disclosure has been described in terms of various specific embodiments, those skilled in the art will recognize that the disclosure can be practiced with modification within the spirit and scope of the claims.

What is claimed is:

1. A method of forming a tubular structure, said method comprising:
mechanically pickling a metal strip, the metal strip including opposing first and second surfaces;
stippling indicia onto the first surface of the metal strip, wherein the indicia includes an informational pattern; and
forming the metal strip into the tubular structure such that the first surface forms an interior surface of the tubular structure.

2. The method according to claim 1, wherein each of the first and second surfaces extends from a first longitudinally extending edge of the metal strip to a second longitudinally extending edge of the metal strip, said forming the metal strip into the tubular structure comprises coupling the first edge and the second edge together along a longitudinal seam.

3. The method according to claim 2, wherein said coupling the first edge and the second edge together comprises welding the first edge and the second edge together along the longitudinal seam.

4. The method according to claim 1, wherein said forming the metal strip into the tubular structure comprises forming the metal strip into the tubular structure having a rectangular cross-section.

5. The method according to claim 1, wherein said forming the metal strip into the tubular structure comprises forming the metal strip into the tubular structure having a circular cross-section.

6. The method according to claim 1, wherein said forming the metal strip into the tubular structure comprises forming the metal strip into the tubular structure having a wall thickness of about 0.5 inches or less.

7. The method according to claim 1, wherein said stippling indicia onto the first surface of the metal strip comprises encoding at least one of a manufacturer name, a manufacture location, a date of manufacture, a material batch number associated with the metal strip, and a manufacturing line identification associated with said forming the metal strip into the tubular structure.

8. The method according to claim 1, wherein said stippling indicia onto the first surface of the metal strip comprises stippling alphanumeric characters onto the first surface of the metal strip.

9. The method according to claim 1, further comprising uncoiling the metal strip from a coil.

10. The method according to claim 1, further comprising applying a coating to the interior surface after said forming the metal strip into the tubular structure.

11. The method according to claim 1, wherein said mechanically pickling the metal strip is performed prior to said stippling indicia onto the first surface of the metal strip.

12. The method according to claim 1, wherein said mechanically pickling the metal strip comprises blasting a slurry of fine metallic particles in a carrier liquid against the metal strip.

13. A system for forming a tubular structure, said system comprising:
a pickling chamber configured to mechanically pickle a metal strip, the metal strip including opposing first and second surfaces;
a stippling device configured to receive the metal strip from said pickling chamber and to stipple indicia onto the first surface of the metal strip, wherein the indicia includes an informational pattern; and
a forming device configured to receive the metal strip from said stippling device and to form the metal strip into the tubular structure such that the first surface forms an interior surface of the tubular structure.

14. The system according to claim 13, wherein each of the first and second surfaces extends from a first longitudinally extending edge of the metal strip to a second longitudinally extending edge of the metal strip, said forming device is further configured to couple the first edge and the second edge together along a longitudinal seam.

15. The system according to claim 14, wherein said forming device is further configured to weld the first edge and the second edge together along the longitudinal seam.

16. The system according to claim 13, wherein said forming device is configured to form the metal strip into the tubular structure having a rectangular cross-section.

17. The system according to claim 13, wherein said forming device is configured to form the metal strip into the tubular structure having a circular cross-section.

18. The system according to claim 13, wherein said forming device is configured to form the metal strip into the tubular structure having a wall thickness of about 0.5 inches or less.

19. The system according to claim 13, wherein said stippling device is configured to encode at least one of a manufacturer name, a manufacture location, a date of manufacture, a material batch number associated with the metal strip, and a manufacturing line identification associated with said system into the tubular structure.

20. The system according to claim 13, wherein said pickling chamber is configured to blast a slurry of fine metallic particles in a carrier liquid against the metal strip.
